(19) United States
(12) Patent Application Publication
(10) Pub. No.: US 2025/0211961 A1
(43) Pub. Date: Jun. 26, 2025

(54) COMMUNICATION NETWORK DEVICES, MONITORING SYSTEM AND METHODS

(71) Applicant: Telefonaktiebolaget LM Ericsson (publ), Stockholm (SE)

(72) Inventors: Francesco ATTANASIO, Roccapiemonte (SA) (IT); Daniele GAITO, Pagani (IT); Maurizio DE MASI, Massa Lubrense (Naples) (IT)

(73) Assignee: Telefonaktiebolaget LM Ericsson (publ), Stockholm (SE)

(21) Appl. No.: 18/845,640

(22) PCT Filed: Mar. 11, 2022
(86) PCT No.: PCT/EP2022/056397

§ 371 Date: Sep. 10, 2024

(51) Int. Cl. H04W 4/90; H04W 36/00

(52) U.S. Cl. CPC H04W 4/90; H04W 36/00837

(57) ABSTRACT

A communication network device (300) hosting a data senses function, DSF, network element, NE. The communication network device is operative to: —receive, from a point of monitoring, POM, (200) an information request message on an internal communication interface (XS1) of a communication network, including event reporting information parameters: —information identifying a monitoring target; and —at least one event type, occurrence associated with the monitoring target a public agency, PA, (502) has requested to receive notification of; —receive, from at least one electronic sense function, ESF, (400) event data including monitoring locations and senses data detected at monitoring locations; —determine that received event data includes a monitoring location matching the monitoring target and senses data matching said event type; and —in response, send an event notification message to the POM including event information including information identifying said matching monitoring location and said matching event type.

### TECHNICAL FIELD

The invention relates to communication network devices hosting a monitoring administration function, M-ADMF, a point of monitoring, POM, and a data senses function, DSF, network element, respectively. The invention further relates to a monitoring system comprising communication network devices hosting monitoring administration function, M-ADMF, point of monitoring, POM, and data senses function, DSF, network elements. The invention further relates to a computer program, a computer program product and a method of operating an M-ADMF, a method of operating a POM, and a method of operating a DSF.

### BACKGROUND

Lawful Interception of telecommunications by a Law Enforcement Agency, LEA, is defined in various ETSI and 3GPP standards. LEA is an organization authorized by a lawful authorization based on the applicable jurisdiction to request and receive the results of telecommunications interceptions of an interception target. The target is a person of interest and/or user equipment possessed or used by the person of interest being surveyed by the LEA.

3GPP standard TS 33.127, such as in V16.6.0, specifies the architecture and functions required to support Lawful Interception of communications in 3GPP networks. ETSI standard GR NFV-SEC 011 V1.1.1, in particular section 6.2.1, describes a high-level architecture for lawful interception in a virtualized environment. Entities are logically represented, therefore it does not necessary reflect separate physical entities. The LI system comprises a LEA network and a Communications Service Provider, CSP, network. The LEA communicates with the CSP network through a network interface, called Handover Interface, HI. LEA comprises a Warrant Issuing Authority/Warrant Issuing Authority device and a Law Enforcement Monitoring Facility, LEMF. The Warrant Issuing Authority issues an intercept request, e.g., lawful authorization or warrant to the CSP through a first Handover Interface, HI1. The LEMF collects the intercepted information of the interception target. The LEMF communicates with an LI site through a second Handover Interface, HI2, for receiving Intercept Related Information, IRI, and through a third Handover Interface, HI3, for receiving Content of Communication, CC. Interfaces HI1, HI2, and HI3 are specified in more detail in the ETSI TS 102 232-1 V3.21.1 standard, “Lawful Interception (LI); Part 1: Internal Network Interface X1 for Lawful Interception”.

The LI site comprises an LI Administration Function, ADMF, and a Mediation and Delivery Function, MF/DF. The LI ADMF communicates with the MF/DF through an X1_2 interface and an X1_3 interface. IRI are collection of information or data associated with telecommunications services involving the interception target identity, specifically call associated information or data (e.g., unsuccessful call attempts), service associated information or data (e.g., service profile management by subscriber) and location information. The CC is information exchanged between two or more users of a telecommunications service, excluding IRI. The MF receives IRI and CC and transforms them from internal interface format to Handover Interface format. The DF will then handle dispatching of said data to the one or more designated LEAs.

Mission Critical Services, MCSs, telecommunication services are services that require preferential handling compared to normal telecommunication services, e.g., in support of public safe agencies or critical infrastructure industries. MCSs can be used for public safety applications such as first responders and also for general commercial applications by critical infrastructure industries, such as utility companies and rail transport industries. MCS Protocol specification is provided in 3GPP standard TS 24.481, such as in version 16.3.0 Release 16.

### SUMMARY

It is an object to enable improved monitoring for public safety, security or defence purposes.

A first aspect provides a communication network device hosting a monitoring administration function, M-ADMF, network element, NE. The communication network device comprises interface circuitry, at least one processor and memory comprising instructions executable by the at least one processor whereby the communication network device is operative as follows. The communication network device is operative to receive, from a public agency, PA, a monitoring activation request message on a handover interface of a communication network. The monitoring activation request message includes event reporting information parameters. The event reporting information parameters include information identifying a monitoring target and at least one event type, occurrence of which at the monitoring target the PA is requesting to receive notification of. The communication network device is further operative to send an activate task message to a point of monitoring, POM, on a first internal communication interface of the communication network. The activate task message includes the event reporting information parameters received in the monitoring activation request message.

The communication network device hosting an M-ADMF NE may enable reporting of relevant monitoring events to Public Safety, Defence Agencies and Critical Infrastructure industries, to prevent environmental crimes and enhance public safety and investigation capabilities. The communication network device may enable Public Safety and Defence Agencies to obtain actionable investigation insights from monitoring target related impacting events. The communication network device may enable improved protection of critical assets in a complete mission critical solution. The communication network device may enable public authorities to monitor dynamically one or more location areas of interest allowing them to plan an appropriate emergency response. The communication network device may enable public authorized authorities to prevent disasters or crimes more effectively and more easily compared to previous technologies.

In an embodiment, the monitoring target is at least one of a geographic area, a building, or a structure. The communication network device may enable improved protection of critical buildings, structures or sensitive geographic areas.

In an embodiment, the at least one event type is at least one of pollution detection, explosive material detection, flammable material detection, natural gas emission detection, toxic gas leak detection, toxic spill, spoilage or contamination detection, biological weapon detection, chemical weapon detection or drug detection. The communication network device may enable Public Safety and Defence Agencies to obtain actionable investigation insights from wide range of impacting events.

In an embodiment, the handover interface has an HI1 lawful interception handover interface format. The first internal communication interface has an X1 lawful interception internal network interface format. This may ensure that communications are secure and may enable the communication network device to be incorporated within a lawful interception, LI, system.

In an embodiment, the M-ADMF NE includes a monitoring control function, MCF, and a monitoring provisioning function, MPF. The communication network device is operative to receive, at the MCF, the monitoring activation request message on the handover interface. The communication network device is further operative to obtain the event reporting information parameters from the monitoring activation request message and to provide the event reporting information parameters to the MPF. The communication network device is operative to send the activate task message from the MPF to the POM on the first internal communication interface.

In an embodiment, the communication network device is further operative to form the activate task message by mapping the information identifying a monitoring target and the at least one event type from the monitoring activation request message into the activate task message.

Corresponding embodiments and advantages apply also to the monitoring system and the method of operating an M-ADMF described below.

A second aspect provides a communication network device hosting a point of monitoring, POM, network element, NE. The communication network device comprises interface circuitry, at least one processor and memory comprising instructions executable by the at least one processor whereby the POM NE is operative as follows. The communication network device is operative to receive, from a monitoring administration function, M-ADMF, an activate task message on a first internal communication interface of a communication network. The activate task message includes event reporting information parameters. The event reporting information parameters include information identifying a monitoring target and at least one event type, occurrence of which at the monitoring target a public agency, PA, has requested to receive notification of. The communication network device E is further operative to send an event information request message to a data senses function, DSF, of the communication network. The event information request message includes the event reporting information parameters received in the activate task message. The communication network device is further operative to receive event notification messages from the DSF. The event notification messages include event information. The event information includes information identifying a monitoring target at which at least one event has been detected and at least one event type detected at the monitoring target.

The communication network device hosting a POM NE may enable reporting of relevant monitoring events to Public Safety, Defence Agencies and Critical Infrastructure industries, to prevent environmental crimes and enhance public safety and investigation capabilities. The communication network device may enable Public Safety and Defence Agencies to obtain actionable investigation insights from monitoring target related impacting events. The communication network device may enable improved protection of critical assets in a complete mission critical solution. The communication network device may enable public authorities to monitor dynamically one or more location areas of interest allowing them to plan an appropriate emergency response. The communication network device may enable public authorized authorities to prevent disasters or crimes more effectively and more easily compared to previous technologies.

In an embodiment, the communication network device is further operative to send a monitoring related information, MRI, message to a mediation function on a second internal communication interface of the communication network. The MRI message includes the event information.

In an embodiment, the second internal communication interface has an X2 lawful interception internal network interface format. This may ensure that communications are secure and may enable the communication network device to be incorporated within a lawful interception, LI, system.

In an embodiment, the POM NE is further operative to form the event information request message by mapping the event reporting information parameters from the activate task message into the event information request message.

Corresponding embodiments and advantages apply also to the monitoring system and the method of operating a POM described below.

A third aspect provides a communication network device hosting a data senses function, DSF, network element, NE. The communication network device comprises interface circuitry, at least one processor and memory comprising instructions executable by the at least one processor whereby the communication network device is operative as follows. The communication network device is operative to receive, from a point of monitoring, POM, an information request message on an internal communication interface of a communication network. The information request message includes event reporting information parameters. The event reporting information parameters include information identifying a monitoring target and at least one event type, occurrence of which at the monitoring target a public agency, PA, has requested to receive notification of. The communication network device is further operative to receive event data from at least one electronic sense function, ESF, on a further internal communication interface of the communication network. Event data includes monitoring locations and senses data detected at monitoring locations. The communication network device is further operative to determine that received event data includes a monitoring location matching the monitoring target and senses data detected at said monitoring location matching the at least one event type occurrence of which the PA has requested to receive notification of. The communication network device is further operative to, in response to said determining, send an event notification message to the POM. The event notification message includes event information. The event information includes information identifying the monitoring location matching the monitoring target and the at least one event type detected at said monitoring location matching the at least one event type occurrence of which the PA has requested to receive notification of.

The communication network device hosting a DSF may advantageously determine the occurrence of monitoring target related impacting events based on received senses data. The communication network device hosting a DSF NE may enable reporting of relevant monitoring events to Public Safety, Defence Agencies and Critical Infrastructure industries, to prevent environmental crimes and enhance public safety and investigation capabilities. The communication network device may enable Public Safety and Defence Agencies to obtain actionable investigation insights from monitoring target related impacting events. The communication network device may enable improved protection of critical assets in a complete mission critical solution. The communication network device may enable public authorities to monitor dynamically one or more location areas of interest allowing them to plan an appropriate emergency response. The communication network device may enable public authorized authorities to prevent disasters or crimes more effectively and more easily compared to previous technologies.

In an embodiment, the communication network device is further operative to determine that triggering of new senses data collection by the at least one ESF is required and in response to said determining, send a senses data trigger message to the at least one ESF.

In an embodiment, the at least one ESF is at least one of an electronic nose function, ENF, operative to receive smell data from an electronic nose, an electronic tongue function, ETF, operative to receive taste data from an electronic tongue, and an electronic eye function, EEF, operative to receive visual data from an electronic eye. The communication network device hosting a DSF may advantageously determine the occurrence of monitoring target related impacting events based on received senses data, including one or more of smell data, taste data and visual data. The communication network device may enable improved detection of events impacting critical buildings or structures, or sensitive geographical areas, which may enable improved public safety, security, crime prevention or crime detection.

Corresponding embodiments and advantages apply also to the monitoring system and the method of operating a DSF described below.

A fourth aspect provides a monitoring system comprising a first communication network device hosting a monitoring administration function, M-ADMF, network element, NE, a second communication network device hosting a point of monitoring, POM, network element, NE, and third communication network device hosting a data senses function, DSF, network element, NE. The first communication network device comprises interface circuitry, at least one processor and memory comprising instructions executable by the at least one processor whereby the first communication network device is operative as follows. The first communication network device is operative to receive, from a public agency, PA, a monitoring activation request message on a handover interface of a communication network. The monitoring activation request message includes event reporting information parameters. The event reporting information parameters include information identifying a monitoring target and at least one event type, occurrence of which at the monitoring target the PA is requesting to receive notification of. The first communication network device is further operative to send an activate task message to the POM NE, on a first internal communication interface of the communication network. The activate task message includes the event reporting information parameters received in the monitoring activation request message. The second communication network device comprises interface circuitry, at least one processor and memory comprising instructions executable by the at least one processor whereby the second communication network device is operative as follows. The second communication network device is operative to receive, from the M-ADMF, the activate task message on the first internal communication interface of the communication network. The activate task message includes the event reporting information parameters. The second communication network device is further operative to send an event information request message to the DSF. The event information request message includes the event reporting information parameters received in the activate task message. The second communication network device is further operative to receive event notification messages from the DSF. The event notification messages include event information. The event information includes information identifying a monitoring target at which at least one event has been detected and at least one event type detected at the monitoring target. The third communication network device comprises interface circuitry, at least one processor and memory comprising instructions executable by the at least one processor whereby the third communication network device is operative as follows. The third communication network device is operative to receive, from the POM, the information request message on the internal communication interface of the communication network. The information request message includes the event reporting information parameters. The third communication network device is further operative to receive event data from at least one electronic sense function, ESF, on a further internal communication interface of the communication network. Event data includes monitoring locations and senses data detected at monitoring locations. The third communication network device is further operative to determine that received event data includes a monitoring location matching the monitoring target and senses data detected at said monitoring location matching the at least one event type occurrence of which the PA has requested to receive notification of. The third communication network device is further operative to, in response to said determining, send an event notification message to the POM. The event notification message includes event information. The event information includes information identifying the monitoring location matching the monitoring target and the at least one event type detected at said monitoring location matching the at least one event type occurrence of which the PA has requested to receive notification of.

The monitoring system may enable reporting of relevant monitoring events to Public Safety, Defence Agencies and Critical Infrastructure industries, to prevent environmental crimes and enhance public safety and investigation capabilities. The monitoring system may enable Public Safety and Defence Agencies to obtain actionable investigation insights from target related impacting events. The monitoring system may enable improved protection of critical assets in a complete mission critical solution. The monitoring system may enable public authorities to monitor dynamically one or more location areas of interest allowing them to plan an appropriate emergency response. The monitoring system may enable public authorized authorities to prevent disasters or crimes more effectively and more easily compared to previous technologies.

In an embodiment, the monitoring system further comprises at least one fourth communication network device hosting an electronic sense function, ESF, network element. The fourth communication network device comprising interface circuitry, at least one processor and memory comprising instructions executable by the at least one processor whereby the fourth communication network device is operative to receive sense data from a sensing device and send the sense data to the DSF.

In an embodiment, the ESF is one of an electronic nose function, ENF, operative to receive smell data from an electronic nose sensing device, an electronic tongue function, ETF, operative to receive taste data from an electronic tongue sensing device, and an electronic eye function, EEF, operative to receive visual data from an electronic eye sensing device.

A fifth aspect provides a method of operating a monitoring administration function, M-ADMF. The method comprises receiving, from a public safety agency, PA, a monitoring activation request message on a handover interface of a communication network. The monitoring activation request message includes event reporting information parameters. The event reporting information parameters include information identifying a monitoring target and at least one event type, occurrence of which at the monitoring target the PA is requesting to receive notification of. The method further comprises sending an activate task message to a point of monitoring, POM, on a first internal communication interface of the communication network. The activate task message includes the event reporting information parameters received in the monitoring activation request message.

A sixth aspect provides a method of operating a point of monitoring, POM. The method comprises receiving, from a monitoring administration function, M-ADMF, an activate task message on a first internal communication interface of a communication network. The activate task message includes event reporting information parameters. The event reporting information parameters include information identifying a monitoring target and at least one event type, occurrence of which at the monitoring target a public safety agency, PA, has requested to receive notification of. The method further comprises sending an event information request message to a data senses function, DSF, of the communication network. The event information request message includes the event reporting information parameters received in the activate task message. The method further comprises receiving event notification messages from the DSF. The event notification messages include event information. The event information includes information identifying a monitoring target at which at least one event has been detected and at least one event type detected at the monitoring target.

A seventh aspect provides a method of operating a data senses function, DSF. The method comprises receiving, from a point of monitoring, POM, an information request message on an internal communication interface of a communication network. The information request message includes event reporting information parameters. The event reporting information parameters include information identifying a monitoring target and at least one event type, occurrence of which at the monitoring target a public safety agency, PA, has requested to receive notification of. The method further comprises receiving event data from at least one electronic sense function, ESF, on a further internal communication interface of the communication network. Event data includes monitoring locations and senses data detected at monitoring locations. The method further comprises determining that received event data includes a monitoring location matching the monitoring target and senses data detected at said monitoring location matching the at least one event type occurrence of which the PA has requested to receive notification of. The method further comprises in response to said determining, sending an event notification message to the POM. The event notification message includes event information. The event information includes information identifying the monitoring location matching the monitoring target and the at least one event type detected at said monitoring location matching the at least one event type occurrence of which the PA has requested to receive notification of.

An eighth aspect provides a computer program comprising instructions which when performed by at least one processor cause the at least one processor to perform steps of the above method of operating a monitoring administration function, M-ADMF.

A ninth aspect provides a computer program comprising instructions which when performed by at least one processor cause the at least one processor to perform steps of the above method of operating a point of monitoring, POM.

A tenth aspect provides a computer program comprising instructions which when performed by at least one processor cause the at least one processor to perform steps of the above method of operating a data senses function, DSF.

Embodiments of the invention will now be described, by way of example only, with reference to the accompanying drawings.

### BRIEF DESCRIPTION OF THE DRAWINGS

FIG. 1 is a block diagram illustrating an embodiment of a communications network device hosting a monitoring administration function, M-ADMF, network element, NE;

FIG. 2 is a block diagram illustrating an embodiment of a communications network device hosting a point of monitoring, POM, network element, NE;

FIG. 3 is a block diagram illustrating an embodiment of a communications network device hosting a data senses function, DSF, network element, NE;

FIG. 4 is a block diagram illustrating an embodiment of a communications network device hosting an electronic sense function, ENF, network element, NE;

FIGS. 5 and 6 are block diagrams illustrating embodiments of a monitoring system;

FIGS. 7 to 9 are flowcharts illustrating embodiments of method steps; and

FIGS. 10 and 11 are signalling diagrams illustrating an exchange of signals in an embodiment of a monitoring system.

### DETAILED DESCRIPTION

The same reference numbers are used for corresponding features in different embodiments.

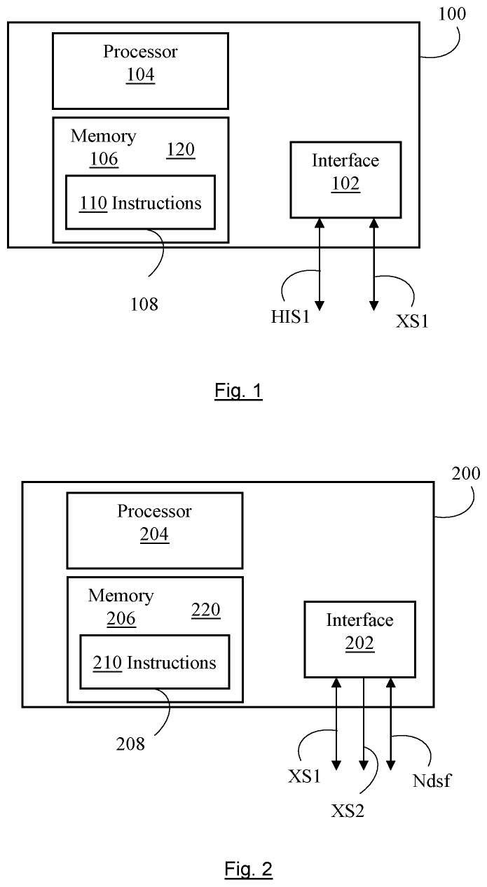

Referring to FIG. 1, an embodiment provides a communication network device 100 hosting a monitoring administration function, M-ADMF, network element, NE. The communication network device comprises interface circuitry 102, a processor 104 and memory 106. The memory comprises instructions 110 executable by the at least one processor whereby the communication network device 100 is operative to receive a monitoring activation request message from a public agency, PA. The PA may, for example, be a public safety agency, PSA, or a Defence Agency, DA.

The monitoring activation request message is received on a handover interface of a communication network. The monitoring activation request message includes event reporting information parameters, which include:
information identifying a monitoring target; and
at least one event type, occurrence associated with the monitoring target the PA is requesting to receive notification of.

The communication network device is further operative to send an activate task message to a point of monitoring, POM, on a first internal communication interface of the communication network. The activate task message includes the event reporting information parameters received in the monitoring activation request message.

In an embodiment, the monitoring target is at least one of a geographic area, a building, or a structure. For example, buildings, sensitive geographic areas, critical structures such as dams, bridges, roads, rail networks, ports, airports, mines, utilities infrastructure, etc.

In an embodiment, the at least one event type is at least one of pollution detection, explosive material detection, flammable material detection, natural gas emission detection, toxic gas leak detection, toxic spill, spoilage or contamination detection, biological weapon detection, chemical weapon detection or drug detection.

In an embodiment, the handover interface has an HI1 lawful interception handover interface format and is referred to herein as the handover interface for senses 1, HIS1. The first internal communication interface has an X1 lawful interception internal network interface format and is referred to herein as the internal communication interface for senses 1, XS1.

The HI1 lawful interception handover interface is the interface for warrant information; it is specified in ETSI TS 103 120, such as in V1.10.1. The X1 lawful interception internal network interface allows a Lawful Interception system to provision tasks on a Network Function (NF); it is specified in ETSI TS 103 221-1, such as in V1.7.1.

In an embodiment, the monitoring activation request message is a Monitoring TaskObject received from the PA on HIS1. The Monitoring TaskObject includes the event reporting information parameters in a number of Fields, as detailed in Table 1:

TABLE 1
List of fields in Monitoring TaskObject

| Field | Description |
|---|---|
| Reference | Monitoring Identifier (MID) assigned to the product of task. |
| TimeSpan | Indicates the period for which task should occur, as well as |
| | provisioning and deprovisioning times. |
| DeliveryDetails | Destination(s) for the filtered Monitoring data. |
| CSPID | Describes the Communication Service Provider, CSP, required to |
| | implement the Task |
| TypeofMonitoring | The at least one event type which the PA is subscribing to receive |
| | notification of, e.g.: pollution detection, explosive material |
| | detection, flammable material detection, natural gas emission |
| | detection, toxic gas leak detection, toxic spill, spoilage or |
| | contamination detection, biological weapon detection, chemical |
| | weapon detection, drug detection. |
| MonitoringIdentifier | The technical identifier used to identify the monitoring target of |
| | task. |

The DeliveryDetails field associates the Monitoring TaskObject to a Public Safety Monitoring Facility (PSMF)/Defense Agency Monitoring Facility (DAMF), to which event information is to be sent, as described in further detail with respect to the DSF and POM below. The DeliveryDetails field has a List of DeliveryDestination structures format as detailed at clause 8.2.8.2 of ETSI TS 103 120, such as in V1.10.1.

In an embodiment, the activate task message is an ActivateTaskRequest message sent on the XS1 internal communication interface. The ActivateTaskRequest message includes a message definition, type of request being made and the event reporting information parameters in a number of request Fields, as detailed in Table 2:

TABLE 2
List of fields in Activate TaskRequest message

| Field | Description |
|---|---|
| ADMF Identifier | Identifies the ADMF uniquely to the NE. Required to match the |
| | details provided by the ADMF's X.509 certificate |
| Server Identifier | Uniquely identifies the Server to the ADMF. |
| MessageTimestamp | Timestamp indicating the time the message was sent by the |
| | requester |
| Version | Version of the present document used for encoding the message |
| XS1TransactionID | Used to correlate Request and Response. |
| XID | Monitoring Identifier (MID) assigned to the product of task. |
| | Uniquely identifies the Task; there may be more than one different |
| | Task relating to the same target identifier (two distinct XIDs). |
| MonitoringIdentifier | The technical identifier used to identify the monitoring target of task. |
| ListOfDIDs | List of Destination Identifiers (DID) referencing the desired delivery |
| | destination records. |
| TypeofMonitoring | The at least one event type which the PA is subscribing to receive |
| | notification of, e.g.: pollution detection, explosive material detection, |
| | flammable material detection, natural gas emission detection, toxic |
| | gas leak detection, toxic spill, spoilage or contamination detection, |
| | biological weapon detection, chemical weapon detection, drug |
| | detection. |

In an embodiment, the M-ADMF includes a monitoring control function, MCF, and a monitoring provisioning function, MPF. The communication network device is operative to receive the monitoring activation request message at the MCF on the handover interface. The communication network device is also operative to obtain the event reporting information parameters from the monitoring activation request message and provide the event reporting information parameters to the MPF. The communication network device is operative to send the activate task message from the MPF to the POM on the first internal communication interface.

In an embodiment, the communication network device is further operative to form the activate task message by mapping the information identifying a monitoring target and the at least one event type from the monitoring activation request message into the activate task message.

In an embodiment, referring to Table 1 and Table 2, an ActivateTaskRequest message is formed by mapping the MonitoringIdentifier and TypeOfMonitoring field contents from the Monitoring TaskObject into the ActivateTaskRequest message.

In an embodiment, the XS1 ActivateTaskRequest message has an XML format. For example, the ActivateTaskRequest message may have the following format:

<RequestContainer>
<XS1Request>
<ADMF Identifier>admin8997</ADMF Identifier>
<Server Identifier>E-NoseServer1</Server Identifier>
<MessageTimestamp>2021-07-08T18:00:00.012345+02:00</MessageTimestamp>
<Version>1.0.0</Version>
<XS1TransactionID>765d2148-f87a-35e3-b756-544513165012</XS1TransactionID>
<ActiveTaskRequest>
<XID>341f5467-e89b-21d3-b478-526624154111</XID>
<MonitoringIdentifiers>Land of Fires Area Street</MonitoringIdentifiers>
<TypeofMonitoring>pollution detection</TypeofMonitoring>
<ListOfDIDs>10.139.120.137,10.120.140.221</ListOfDIDs>
<ListOfMediationDetails></ListOfMediationDetails>
<CorrelationID></CorrelationID>
<ImplicitDeactivationAllowed>False</ImplicitDeactivationAllowed>
<ProductID></ProductID>
<TaskDetailsExtensions>
</TaskDetailsExtensions>
</ActiveTaskRequest>
</XS1Request>
</RequestContainer>

In a further example, the ActivateTaskRequest message may have the following format:

<RequestContainer>
<XS1Request>
<ADMF Identifier>admin8997</ADMF Identifier>
<Server Identifier>E-NoseServer8</Server Identifier>
<MessageTimestamp>2021-07-13T19:00:00.012345+02:00</MessageTimestamp>
<Version>1.0.0</Version>
<XS1TransactionID>765d2148-f87a-35e3-b756-544513165133</XS1TransactionID>
<ActiveTaskRequest>
<XID>341f5467-e89b-21d3-b478-526624154133</XID>
<MonitoringIdentifiers>Channel Dam </MonitoringIdentifiers>
<TypeofMonitoring> explosive material detection </TypeofMonitoring>
<ListOfDIDs>10.139.120.138,10.120.140.222</ListOfDIDs>
<ListOfMediationDetails></ListOfMediationDetails>
<CorrelationID></CorrelationID>
<ImplicitDeactivationAllowed>False</ImplicitDeactivationAllowed>
<ProductID></ProductID>
<TaskDetailsExtensions>
</TaskDetailsExtensions>
</ActiveTaskRequest>
</XS1Request>
</RequestContainer>

Referring to FIG. 2, an embodiment provides a communication network device 200 hosting a point of monitoring, POM, network element, NE. The communication network device comprises interface circuitry 202, a processor 204 and memory 206 comprising instructions 210 executable by the at least one processor whereby the communication network device 200 is operative to receive an activate task message from a monitoring administration function, M-ADMF.

The activate task message is received on a first internal communication interface of a communication network. The activate task message includes event reporting information parameters, which include:
information identifying a monitoring target; and
at least one event type, occurrence associated with the monitoring target the PA is requesting to receive notification of.

The communication network device 200 is further operative to send an event information request message to a data senses function, DSF, of the communication network. The event information request message includes the event reporting information parameters received in the activate task message.

The communication network device 200 is further operative to receive event notification messages from the DSF. The event notification messages include event information including:
information identifying a monitoring target at which at least one event has been detected; and
at least one event type detected at the monitoring target.

In an embodiment, the event information request message is an Nndsf_Info_Request message and includes a number of request Fields, as detailed in Table 3:

TABLE 3
List of fields in Nndsf_Info_Request message

| Field | Description |
|---|---|
| Notification | Allows the Event Receiving Network function to correlate |
| Monitoring Address | notifications received from the Event provider with a subscription |
| Monitoring Identifier | The technical identifier used to identify the monitoring target of task. |
| of Event Reporting | |
| notifUri | List of Destination Identifiers (DID) referencing the desired delivery |
| | destination records. |
| IoSevSubsc | The at least one event type which the PA is subscribing to receive |
| | notification of, e.g.: pollution detection, explosive material detection, |
| | flammable material detection, natural gas emission detection, toxic |
| | gas leak detection, toxic spill, spoilage or contamination detection, |
| | biological weapon detection, chemical weapon detection, drug |
| | detection. |

In an embodiment, the communication network device 200 is further operative to form the event information request message by mapping the event reporting information parameters from the activate task message into the event information request message.

In an embodiment, the communication network device 200 is operative to form a Nndsf_Info_Request message by mapping the event reporting information parameters from the ActivateTaskRequest message into the Nndsf_Info_Request message.

The communication network device 200 translates or maps the TypeofMonitoring field in the ActivateTaskRequest message to an IoSevSubsc field of the Nndsf_Info_Request message. An IoSevSubsc field identifies the type of event, for example Toxic Gases leak detection, being subscribed to. The communication network device also translates or maps the MonitoringIdentifier field in the ActivateTaskRequest message to a Monitoring Identifier of Event Reporting field of the Nndsf_Info_Request message. Within a subscription all IoSevSubsc may be associated with the same Monitoring Identifier of Event Reporting. The communication network device also translates or maps the ListOfDIDs field in the ActivateTaskRequest message to a notifUri field of the Nndsf_Info_Request message. A Notification Monitoring Address field allows the Event Receiving Network function to correlate notifications received from the Event provider with a subscription. The Nndsf_Info_Request message is applicable to both a 5G or a 6G DSF service operation.

The information in the ActivateTaskRequest message fields may be mapped into the Nndsf_Info_Request message fields as shown in Table 4 below:

TABLE 4
Mapping of fields from Activate TaskRequest
to Nndsf_Info_Request

| Activate TaskRequest Field | Nndsf_Info_Request field |
|---|---|
| XID | InfoID |
| TypeofMonitoring | IoSevSubsc |
| MonitoringIdentifier | MonitoringId |
| ListOfDIDs | notifUri |

The DSF acknowledges the Nndsf_Info_Request to the POM and if the request can be parsed, the POM sends an ActivateTaskResponse to the M-ADMF on the XS1 interface. The ActivateTaskResponse may have an xml format as follows:

<ResponseContainer>
<XS1Response>
<ActiveTaskResponse>
</OK-Acknowledged and Completed>
</<ActiveTaskResponse>
</XS1Response>
</ResponseContainer>

In an embodiment, the event notification messages received from the DSF are Ndsf_Delivery_Notify messages comprising a Mission Critical event report to the POM. The communication network device 200 is further operative to sends a Ndsf_Delivery_Notify_Ack message to DSF in to acknowledge receipt of a Ndsf_Delivery_Notify message.

In an embodiment, the communication network device 200 is further operative to send a monitoring related information, MRI, message including the event information to a mediation function. The MRI message is sent on a second internal communication interface of the communication network.

In an embodiment, the second internal communication interface has an X2 lawful interception internal network interface format and is referred to herein as the internal communication interface for senses 2, XS2.

The X2 lawful interception internal network interface is used to transmit intercepted signalling within a Lawful Interception system; it is specified in ETSI TS 103 221-2, such as in V1.4.1.

In an embodiment, the MRI message is a Raw MRI message and the communication network device 200 is operative to translate or map fields of the Ndsf_Delivery_Notify message to fields of the Raw MRI message, to be sent over the XS2 interface. The contents of a Monitoring Target of Event Reporting field of the Ndsf_Delivery_Notify message are translated or mapped to a field Matched Monitoring Identifier of the Raw MRI message. The Monitoring Target of Event Reporting field may comprise a parameter or an enumerated value. The contents of a field evSubsc of the Ndsf_Delivery_Notify message are translated or mapped to a field Event of the Raw RI message. The field Event may comprise a parameter or an enumerated value related to a Monitored Event.

The Raw MRI message is sent from communication network device 200 to a mediation and delivery function 2, MDFS2. The Raw MRI message is sent as a binary stream of XS2 Protocol Data Units (PDUs). An example XS2 PDU format is shown in Table 5 and Table 6:

TABLE 5
XS2 PDU Header fields

| Field | Description |
|---|---|
| Version | The POM shall populate the Version field with the version of the |
| | specification used to create the PDU, given as a 16-bit unsigned |
| | integer. |
| PDU Type | XS2 PDU |
| Header Length | The POM shall populate the Header Length field with the length of the |
| | header in octets, including the mandatory and any conditional fields |
| | that have been populated |
| Payload Length | The POM shall populate the Payload Length field with the length of |
| | the Payload field in octets. |
| Payload Format | The POM shall indicate the format and encoding of the Payload field |
| | by setting the Payload Format field to the appropriate value. |
| . . . | |
| . . . | |
| XID | The MOI shall populate the XID field with the XID associated with the |
| | intercepted product, as assigned by the relevant XS1 interface. |

TABLE 6
XS2 PDU Conditional Attributes

| Field | Description |
|---|---|
| NFID | Network Function ID as received by PCF |
| Timestamp | If used, the POI shall populate the Timestamp field with the |
| | time that the content for the PDU was intercepted. |
| Matched | location |
| Monitoring | |
| Identifier | |
| . . . | |

The communication network device 200 is operative to populate the Raw MRI XS2 PDU Payload field with the event information.

An example of an xml format Raw MRI X2 PDU reporting a pollution detection event in the Payload is as follows:

```
<PDU>
<Version> current version<Version>
<PDUType>2</PDUType>
<HeaderLenght>variable</HeaderLenght>
<PayloadLength>variable</PayloadLength>
<PayloadFormat>4</PayloadFormat>
<PayloadDirection>1<PayloadDirection>
<XID>341f5467-e89b-21d3-b478-526624154111</XID>
<CorrelationId><CorrelationId>
<ConditionalAttribute>
    <NFID>EN_System_1</NFID>
    <Timestamp>2021-07-09T19:00:00.012345+02:00</Timestamp>
    <Matched Monitoring Identifier>Land of Fires Area Street
    1</Matched Monitoring Identifier>
</ConditionalAttribute>
        <Payload>
  <EventContent>
        <Event>PollutionDetection</Event>
            <monRespdata>
      <pollutant1>carbon monoxide</pollutant1>
      <pollutant2>sulfur oxides</pollutant2>
      <pollutant3>nitrogen oxides</pollutant3>
            </monRespdata>
          </EventContent>
        </Payload>
</PDU>
```

Using the event information reported above, a PSA/DA could identify unauthorized rubbish dumps as a result of illegal waste burning. An xml format Raw MRI X2 PDU reporting an explosive material detection event may have a Payload as follows:

```
<Payload>
  <EventContent>
<Event>ExplosiveMaterialDetection</Event>
    <monRespdata>
      <explosive1>Nitroglycerin</explosive1>
      <explosive2>RDX</explosive2>
      <explosive3>TNT</explosive3>
    </monRespdata>
  </EventContent>
</Payload>
```

Using this event information, a PSA/DA may, for example, identify the detection of explosive material at a dam, due to a terrorist attack.

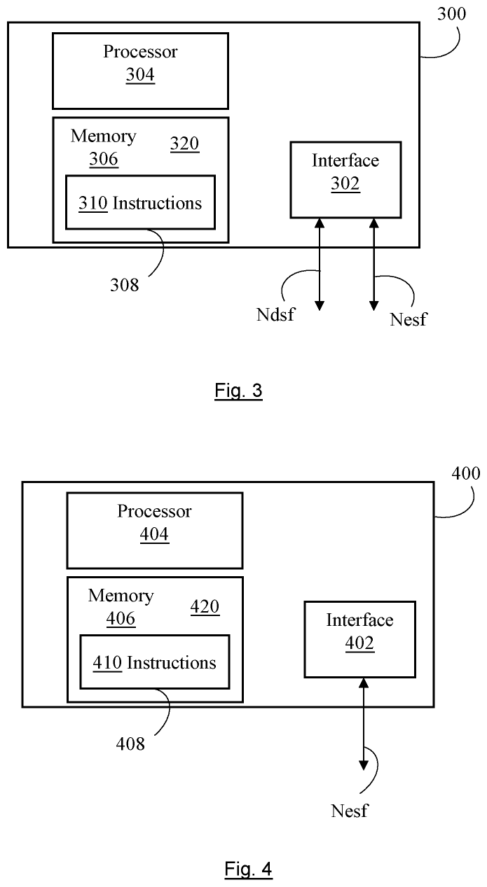

Referring to FIG. 3, an embodiment provides a communication network device 300 hosting a data senses function, DSF, network element, NE. The communication network device comprises interface circuitry 302, a processor 304 and memory 306 comprising instructions 310 executable by the processor whereby the communication network device is operative to receive an information request message from a point of monitoring, POM.

The information request message is received on an internal communication interface of a communication network and includes event reporting information parameters including:
information identifying a monitoring target; and
at least one event type, occurrence associated with the monitoring target a public agency, PA, has requested to receive notification of.

The communication network device 300 is further operative to receive event data from at least one electronic sense function, ESF. The event data is received on a further internal communication interface of the communication network. The event data includes monitoring locations and senses data detected at monitoring locations.

The communication network device 300 is further operative to determine that received event data includes a monitoring location matching the monitoring target. The communication network device 300 is further operative to determine that senses data detected at the matched monitoring location matches the at least one event type occurrence of which associated with the matched monitoring location the PA has requested to receive notification of.

The communication network device 300 is further operative to, in response to said determining, send an event notification message to the POM. The event notification message includes event information including:
information identifying the monitoring location matching the monitoring target; and
the at least one event type detected at said monitoring location matching the at least one event type occurrence of which the PA has requested to receive notification of.

In an embodiment, communication network device 300 is operative to, in response to detecting one or more events subscribed to by the PA, send a Ndsf_Delivery_Notify message to the POM. The Ndsf_Delivery_Notify message includes a Mission Critical event report to the POM.

An event is detected if the communication network device determines that senses data detected at one or more matched monitoring locations matches the at least one event type occurrence of which associated with the matched monitoring locations the PA has requested to receive notification of. The communication network device may be operative to apply one or more Event filters to received monitoring locations and senses data, and to determine that an event has occurred for which one or more Event filters match. Event Filters may be used to specify a condition to match for notifying an event. For example, an event filter may specify a condition that “a List of parameters or enumeration values must match”.

In an embodiment, the communication network device 300 is further operative to determine that triggering of new senses data collection by the at least one ESF is required and, in response, to send a senses data trigger message to the at least one ESF.

FIG. 4 illustrates a communication network device 400 hosting an electronic sense function, ESF, network element. The communication network device 400 comprises interface circuitry 402, a processor 404 and memory 406 comprising instructions 410 executable by the processor whereby the communication network device 400 is operative to receive sense data from a sensing device and send the event sense data and a monitoring location of the sensing device to a data senses function, DSF. The event data includes the sense data and a location of the sensing device.

In an embodiment, the at least one ESF is at least one of an electronic nose function, ENF, operative to receive smell data from an electronic nose, an electronic tongue function, ETF, operative to receive taste data from an electronic tongue, and an electronic eye function, EEF, operative to receive visual data from an electronic eye.

As reported in Ordoñez Araque et al “Electronic Nose, Tongue and Eye: Their Usefulness for the Food Industry”, Vitae, vol. 27, no. 3, 2020, the electronic nose, tongue, and eye are futuristic technologies that have been used for many years. They can increasingly be found in the food industry, where their function is to determine sensory characteristics (smell, aroma, and flavour) and objective visuals, without the subjectivity that can be represented by sensory analysis by people.

The Electronic Nose (EN) is a tool that consists of three main parts: a sample delivery system; an array of gas or chemical sensors; and a pattern recognition system, This technology is normally used to detect simple or complex volatile organic compounds. In a similar way to a human nose, the electronic nose works through a series of sensors. After detecting an aroma, the set of sensors generates a pattern based on the type of smell. The pattern recognition system is trained to interpret and distinguish between various odors based on the pattern. EN has been used in various applications, as set out in Table 7 and reported in Alphus D Wilson and Manuela Baietto, “Applications and advances in electronic-nose technologies,” Sensors (Basel, Switzerland) vol. 9, no. 7 (2009), pages 5099-5148.

TABLE 7
Electronic nose, EN, applications

| Sector | Application area | Specific use examples |
|---|---|---|
| Environmental | Air and Water quality | Pollution detection, |
| | monitoring. | effluents, toxic spills. |
| | Pollution abatement | Malodor emissions, |
| | regulations. | toxic/hazardous gases. |
| | | Control of point-source |
| | | pollution releases. |
| Military | Personnel and | Biological and chemical |
| | population security. | weapons. |
| | Civilian and military | Explosive materials |
| | safety. | detection. |
| Manufacturing | Safety, security, work | Fire alarms. Toxic gas |
| | conditions. | leak detection. |
| Food and | Consumer fraud | Ingredient confirmation, |
| beverage | prevention. | content standards. |
| | Food contamination. | Spoilage, shelf life. |
| Agriculture | Crop protection. | Homeland Security. |
| | Pre- and post-harvest | Pest identification |
| | diseases. | |
| Airline | Public Safety and | Explosive and flammable |
| transportation | Welfare. Passenger | materials detection. |
| | and Personal Security. | |
| Regulatory | Environmental | Air, water, and soil |
| | protection | contamination tests. |
| Scientific | Ecological Studies | Ecosystem functions. |
| Research | | |

The electronic tongue is a multi-channel taste sensor (more than five basic flavors) with global selectivity. It is composed of several types of lipid/polymer membranes to transform information about taste substances into electrical signals uploaded into a computer. Electronic tongue signals are analyzed in a pattern recognition unit to discriminate between similar samples. It is an analytical tool composed of three parts: (1) nonspecific and not very selective chemical sensors that have partial specificity (cross-sensitivity) to different components in a liquid sample; (2) an appropriate method of pattern recognition; (3) multivariate calibration for data processing.

The electronic eye is a computer vision technology that converts optical images into digital images. It uses an image sensor to collect images of objects and uses computer simulation criteria to identify the images to avoid subjective deviation of human vision. The computer vision process generally includes five steps: image acquisition, image processing, feature extraction, pattern recognition, and decision making.

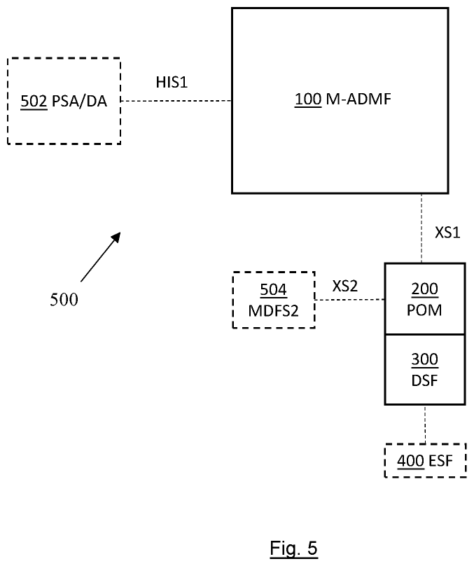

Referring to FIG. 5, an embodiment provides a monitoring system 500 comprising a first communication network device 100 hosting a M-ADMF NE as described above with reference to FIG. 1, a second communication network device 200 hosting a POM NE as described above with reference to FIG. 2, and third communication network device 300 hosting a DSF NE as described above with reference to FIG. 3.

The monitoring system 500 is provided within a communication network which provides communication interfaces. The handover interface, HIS1, is provided between a public agency, PA, for example a public safety agency or a defence agency, PSA/DA, 502. The first internal communication interface, XS1, is provided between the M-ADMF NE and the POM NE, and the second internal communication interface, XS2, is provided between the POM NE and a mediation function, in this example a mediation and delivery function for senses 2, MDFS2, 504.

In an embodiment, the monitoring system 500 further comprises at least one ESF 400 as described above with reference to FIG. 4.

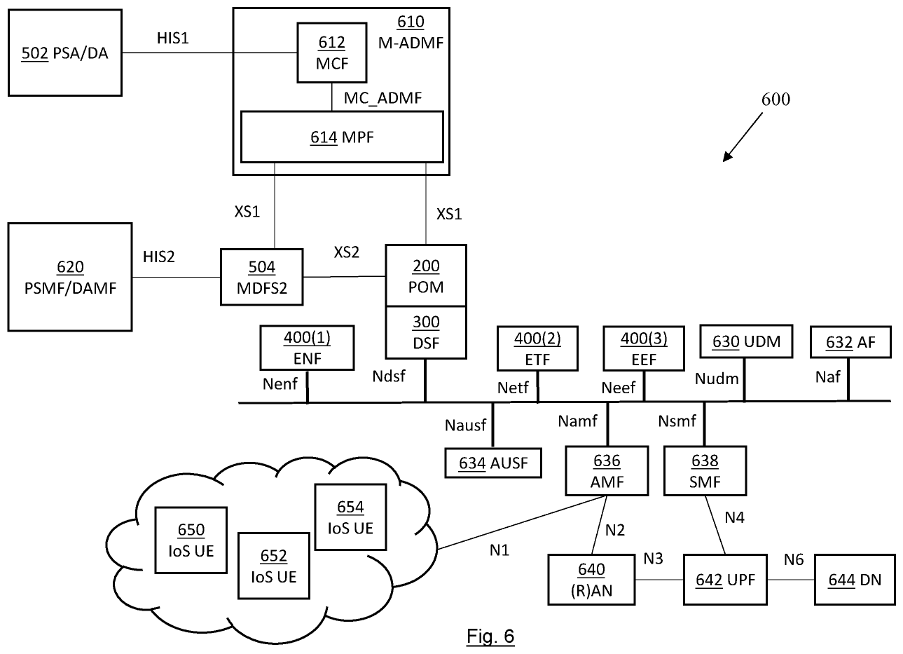

Referring to FIG. 6, an embodiment provides a monitoring system 600 comprising a first communication network device 610 hosting a M-ADMF NE as described above with reference to FIG. 1, a second communication network device 200 hosting a POM NE as described above with reference to FIG. 2, and third communication network device 300 hosting a DSF NE as described above with reference to FIG. 3.

The M-ADMF 610 includes a monitoring control function, MCF, 612 and a monitoring provisioning function, MPF, 614. The first communication network device 610 is operative to receive the monitoring activation request message from the PSA/DA 502 at the MCF on the HIS1 interface. The first communication network device is operative to obtain the event reporting information parameters from the monitoring activation request message and provide the event reporting information parameters to the MPF on an internal interface, MC_ADMF. The communication network device is operative to send the activate task message from the MPF to the second communication network device POM 200 on an XS1 interface. The first communication network device is further operative to provision the MDFS2 504 using an XS1 interface.

The monitoring system 600 further comprises three ESF 400, as described above with reference to FIG. 4; an electronic nose function, ENF, 400(1), an electronic tongue function, ETF, 400(2) and an electronic eye function, EEF, 400(3).

The monitoring system 600 is provided within a 5G communication network which additionally comprises the following network components: a unified data management, UDM, network element 630, an application function, AF, 632, an authentication server function, AUSF, 634, an access and mobility management function, AMF, 636, a session management function, SMF, 638, a (radio) access network, (R)AN, 640, a user plane function, UPF, 642 and a data network, DN, 644. The 5G communication network provides respective communication interfaces, Nenf, Netf, Neef, Nudm, Naf, Nausf, Namf, Nsmf, N1, N2, N3, N4, N6, for the network components.

The monitoring system 600 further comprises Internet of Senses, IoS, user equipment, UEs, 650, 652, 654 comprising sensing devices and a public safety/defence agency monitoring facility, PSMF/DAMF, 620. The IoS UEs are provided at monitoring locations and comprise at least one of an electronic nose, EN, an electronic tongue, ET, or an electronic eye, EE, sensing device. The PSMF/DAMF receives the event information from the MDFS2 on a second handover interface, HIS2, having an LI handover interface 2, HI2, interface format.

The monitoring system 600 provides network connected electronic sense functions, ENF, ETF, EEF, to acquire data from multiple and distributed multi-senses sensors, EN, ET, EE, which is provided to the DSF 300 to determine the occurrence of events which the PSA/DA has subscribed to monitoring of.

The monitoring system 600 may be implemented in a virtualised network function, VNF, environment or native cloud architecture of communication networks including 5G and future 6G.

The new functions introduced in the monitoring system 600 are:
1) Handover Interface for Senses 1 (HIS1) used for requesting subscription, from the Public Safety and Defense Agencies, PAS/DA 502, to notification of specific senses data monitoring events (e.g. Explosive and Flammable detection Events, Pollution Detection Events)
2) XS1 used for requesting/response subscription to notification of specific monitoring events (e.g. Explosive and Flammable detection Events, Pollution Detection Events)
3) XS2 used to report via the Data Senses Function (DSF) 300 monitoring events.
4) When an event is received from Monitoring Related Information-Point of Monitoring (MRI-POM), then the MDFS2 504 shall support reporting to the PSMF/DAMF 620 requested data by Handover Interface for Senses 2 (HIS2).

The ENF 400(1), ETF 400(2) and EEF 400(3) send senses data to the DSF 300 on the respective Nenf, Netf, Neef, communication interfaces, using the following messages:
Nenf_EventExposure_Subscribe Request
Nenf_EventExposure_Subscribe Response
Netf_EventExposure_Subscribe Request
Netf_EventExposure_Subscribe Response
Neef_EventExposure_Subscribe Request
Neef_EventExposure_Subscribe Response

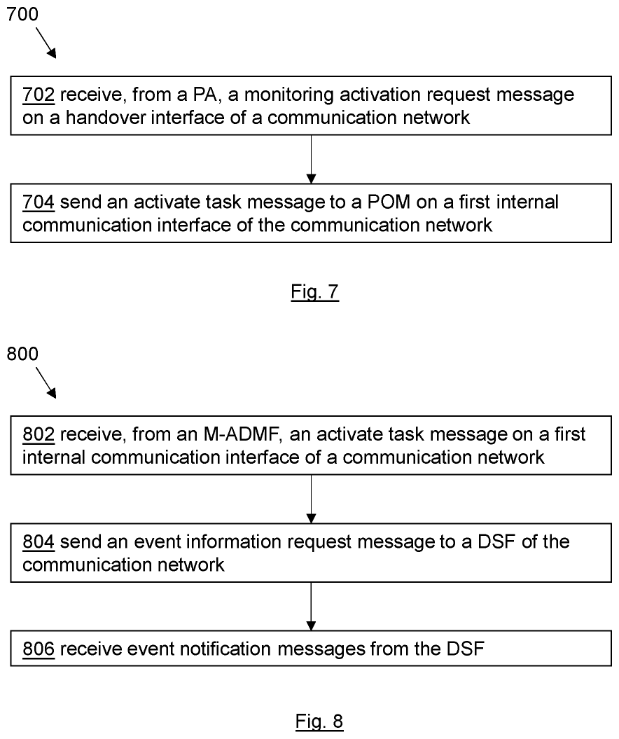

An embodiment provides a method 700 of operating a monitoring administration function, M-ADMF, the method comprising the following steps, as illustrated in FIG. 7.

The method 700 comprises receiving 702 a monitoring activation request message from a public agency, PA, on a handover interface of a communication network. The monitoring activation request message includes event reporting information parameters including:
information identifying a monitoring target; and
at least one event type, occurrence associated with the monitoring target the PA is requesting to receive notification of.

The method further comprises sending 704 an activate task message to a point of monitoring, POM, on a first internal communication interface of the communication network. The activate task message includes the event reporting information parameters received in the monitoring activation request message.

An embodiment provides a method 800 of operating a point of monitoring, POM, the method comprising the following steps, as illustrated in FIG. 8.

The method 800 comprises receiving 802 an activate task message from a monitoring administration function, M-ADMF, on a first internal communication interface of a communication network. The activate task message includes event reporting information parameters including:
information identifying a monitoring target; and
at least one event type, occurrence associated with the monitoring target a public agency, PA, has requested to receive notification of.

The method 800 further comprises sending 804 an event information request message to a data senses function, DSF, of the communication network. The event information request message includes the event reporting information parameters received in the activate task message.

The method 800 further comprises receiving 806 event notification messages from the DSF. The event notification messages include event information including:
information identifying a monitoring target at which at least one event has been detected; and
at least one event type detected at the monitoring target.

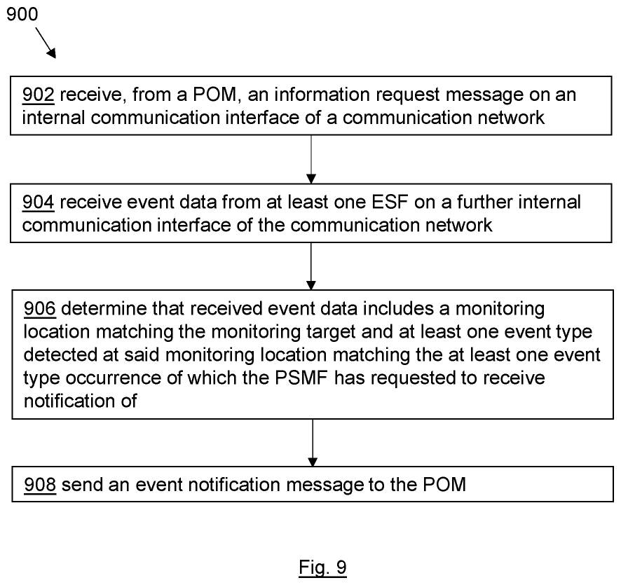

An embodiment provides a method 900 of operating a data senses function, DSF, the method comprising the following steps, as illustrated in FIG. 9.

The method 900 comprises receiving 902, an information request message from a point of monitoring, POM, on an internal communication interface of a communication network. The information request message includes event reporting information parameters including:
information identifying a monitoring target; and
at least one event type, occurrence associated with the monitoring target a public agency, PA, has requested to receive notification of.

The method 900 further comprises receiving 904 event data from at least one electronic sense function, ESF, on a further internal communication interface of the communication network. Event data includes monitoring locations and senses data detected at monitoring locations.

The method 900 further comprises determining 906 that received event data includes a monitoring location matching the monitoring target. The method 900 further comprises determining that senses data detected at the matched monitoring location matches the at least one event type occurrence of which the PA has requested to receive notification of.

The method 900 further comprises, in response to determining the matched monitoring location and at least one event type, sending 908 an event notification message to the POM. The event notification message includes event information including:
information identifying the monitoring location matching the monitoring target; and
the at least one event type detected at the matched monitoring location that matches the at least one event type occurrence of which the PA has requested to receive notification of.

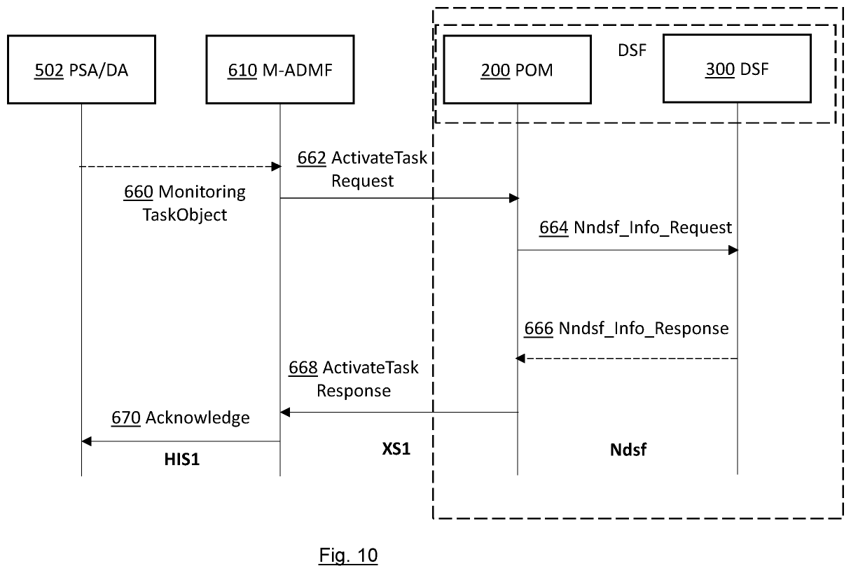

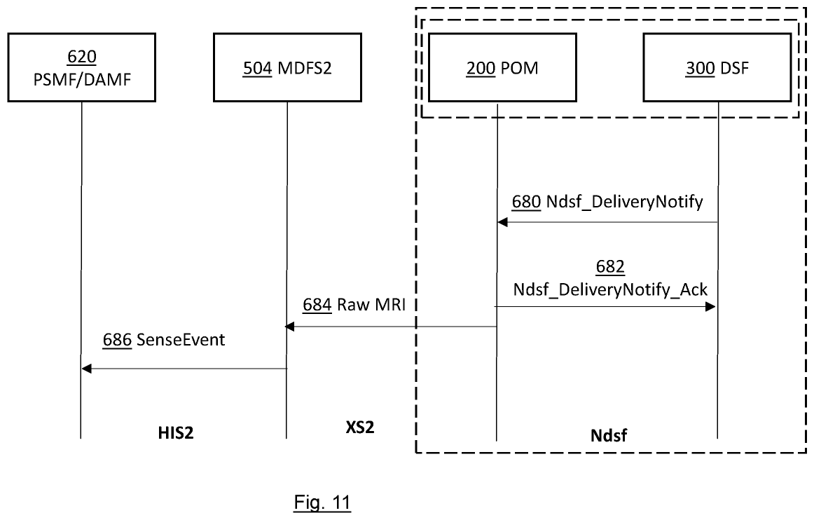

The signalling diagrams of FIGS. 10 and 11 illustrate how the above methods 700, 800, 900 may be applied to the M-ADMF, POM and DSF of a monitoring system, such as the monitoring system 600 described above with reference to FIG. 6.

FIGS. 10 and 11 illustrate the procedure used by the M-ADMF to request event information from the POM, that in turn requests the DSF for event, using Nndsf_Info_Request. When a request for event information is received, the DSF determines whether triggering new senses data collection is needed. The DSF responds with relevant event information to the POM.

The method steps for a PSA/DA subscribing to monitoring of specific event types at a monitoring target are illustrated in FIG. 10. A PSA/DA user creates a Monitoring TaskObject specifying the monitoring location and type of event to be monitored, as described above, and associates it to a Public Safety Monitoring Facility (PSMF)/Defense Agency Monitoring Facility (DAMF), reached with a specific HIS2 interface. The Monitoring TaskObject 660 is sent by the PSA/DA to the M-ADMF 610 on the HIS1 interface.

The MCF, present in the M-ADMF, receives the Monitoring TaskObject 660, derives the event reporting information parameters from the Monitoring TaskObject and provides it to the MPF. The MPF sends an ActivateTaskRequest 662, as described above, to the POM 200 on the XS1 interface. The POM derives the event reporting information parameters from the ActivateTaskRequest and send them in an Nndsf_Info_Request 664 to the DSF 300 on an Ndsf interface. The DSF sends a Nndsf_Info_Reponse 666 back to the POM on Ndsf, to acknowledge the Nndsf_Info_Request. The POM sends an ActivateTaskResponse 668 back to the M-ADMF on XS1 to acknowledge that the ActivateTaskRequest has been actioned. The M-ADMF send an Acknowledge message 670 to the PSA/DA. This completes the subscription of the PSA/DA to monitoring of the monitoring location for occurrence of the specified event type.

As illustrated in FIG. 11, when the DSF 300 determines that an event has occurred of the type and at the specified monitoring location to which the PSA/DA has subscribed, the DSF sends an event notification message, Ndsf_DeliveryNotify 680, to the POM 200 on the Ndsf interface. The Ndsf_DeliveryNotify includes event information relating to the matching event that has occurred. The POM sends an Ndsf_DeliveryNotify_Ack message 682 back to the DSF to acknowledge receipt. The POM sends a Raw MRI message 684 to the MDFS2 on the XS2 interface as a binary stream of XS2 PDUs, as described above; the Raw MRI message includes the event information. The MDFS2 sends a SenseEvent message 686 to the PSMF/DAMF 620 on the HIS2 interface; the SenseEvent message includes the event information.

An embodiment provides a computer program 108 comprising instructions 110 which when performed by at least one processor 104 cause the at least one processor to perform steps of the method 700 of operating a monitoring administration function, M-ADMF.

An embodiment provides a computer program 208 comprising instructions 210 which when performed by at least one processor 204 cause the at least one processor to perform steps of the method 800 of operating a point of monitoring, POM.

An embodiment provides a computer program 308 comprising instructions 310 which when performed by at least one processor 304 cause the at least one processor to perform steps of the method 900 of operating a data senses function, DSF.

An embodiment provides a computer program product 120, here in the form of a memory 106, which comprises a computer readable storage medium on which a computer program 108 as described above is stored.

An embodiment provides a computer program product 220, here in the form of a memory 206, which comprises a computer readable storage medium on which a computer program 208 as described above is stored.

An embodiment provides a computer program product 320, here in the form of a memory 306, which comprises a computer readable storage medium on which a computer program 308 as described above is stored.

1-21. (canceled)

22. A communication network device hosting a monitoring administration function (M-ADMF) network element (NE), the communication network device comprising:
interface circuitry;
processing circuitry including at least one processor; and
memory comprising instructions executable by the processing circuitry wherein the communication network device is operative to:
receive, from a public agency (PA), a monitoring activation request message on a handover interface of a communication network, the monitoring activation request message including event reporting information parameters including:
information identifying a monitoring target; and
at least one event type associated with the monitoring target the PA is requesting to receive notification of, wherein the at least one event type is at least one of pollution detection, explosive material detection, flammable material detection, natural gas emission detection, toxic leak detection, toxic spill, spoilage or contamination detection, or drug detection; and
send an activate task message to a point of monitoring (POM) on a first internal communication interface of the communication network, the activate task message including the event reporting information parameters received in the monitoring activation request message.

23. The communication network device of claim 22, wherein the monitoring target is at least one of a geographic area, a building, or a structure.

24. The communication network device of claim 22, wherein the handover interface has an HI1 lawful interception handover interface format and the first internal communication interface has an X1 lawful interception internal network interface format.

25. The communication network device of claim 22, wherein the M-ADMF includes a monitoring control function (MCF) and a monitoring provisioning function (MPF), and wherein the communication network device is further operative to:
receive, at the MCF, the monitoring activation request message on the handover interface;
obtain the event reporting information parameters from the monitoring activation request message;
provide the event reporting information parameters to the MPF; and
send, from the MPF, the activate task message to the POM on the first internal communication interface.

26. The communication network device of claim 22, wherein the communication network device is further operative to form the activate task message by mapping the information identifying a monitoring target and the at least one event type from the monitoring activation request message into the activate task message.

27. A communication network device hosting a point of monitoring (POM) network element (NE), the communication network device comprising:
interface circuitry;
processing circuitry including at least one processor; and
memory comprising instructions executable by the processing circuitry wherein the communication network device is operative to:
receive, from a monitoring administration function (M-ADMF) an activate task message on a first internal communication interface of a communication network, the activate task message including event reporting information parameters including:
information identifying a monitoring target; and
at least one event type associated with the monitoring target a public agency (PA) has requested to receive notification of, wherein the at least one event type is at least one of pollution detection, explosive material detection, flammable material detection, natural gas emission detection, toxic leak detection, toxic spill, spoilage or contamination detection, or drug detection;
send an event information request message to a data senses function (DSF) of the communication network, the event information request message including the event reporting information parameters received in the activate task message; and
receive event notification messages from the DSF, the event notification messages including event information including:
information identifying a monitoring target at which at least one event has been detected; and
at least one event type detected at the monitoring target.

28. The communication network device of claim 27, wherein the communication network device is further operative to send a monitoring related information (MRI) message to a mediation function on a second internal communication interface of the communication network, the MRI message including the event information.

29. The communication network device of claim 28, wherein the second internal communication interface has an X2 lawful interception internal network interface format.

30. The communication network device of claim 27, wherein the communication network device is further operative to form the event information request message by mapping the event reporting information parameters from the activate task message into the event information request message.

31. A communication network device hosting a data senses function (DSF) network element (NE), the communication network device comprising:
interface circuitry;
processing circuitry including at least one processor; and
memory comprising instructions executable by the processing circuitry wherein the communication network device is operative to:
receive, from a point of monitoring (POM), an information request message on an internal communication interface of a communication network, the information request message including event reporting information parameters including:
information identifying a monitoring target; and
at least one event type, occurrence associated with the monitoring target a public agency, PA, has requested to receive notification of, wherein the at least one event type is at least one of pollution detection, explosive material detection, flammable material detection, natural gas emission detection, toxic leak detection, toxic spill, spoilage or contamination detection, or drug detection;
receive event data from an electronic sense function (ESF) on a further internal communication interface of the communication network, event data including monitoring locations and senses data detected at monitoring locations;
determine that received event data includes a monitoring location matching the monitoring target and senses data detected at said monitoring location matching the at least one event type of which the PA has requested to receive notification of; and
in response to said determining, send an event notification message to the POM, the event notification message including event information including:
information identifying the monitoring location matching the monitoring target; and
the at least one event type detected at said monitoring location matching the at least one event type of which the PA has requested to receive notification of.

32. The communication network device of claim 31, wherein the communication network device is further operative to:
determine that triggering of new senses data collection by the ESF is required; and
in response to said determining, send a senses data trigger message to the ESF.

33. The communication network device of claim 31, wherein the ESF comprises an electronic nose function (ENF) operative to receive smell data from an electronic nose, an electronic tongue function (ETF) operative to receive taste data from an electronic tongue, and/or an electronic eye function (EEF) operative to receive visual data from an electronic eye.

34. A monitoring system comprising:
the first communication network device of claim 22;
a second communication network device hosting the POM; and
a third communication network device hosting a data senses function (DSF).

35. The monitoring system of claim 34, further comprising:
a fourth communication network device hosting an electronic sense function (ESF), the fourth communication network device comprising:
interface circuitry;
processing circuitry including at least one processor; and
memory comprising instructions executable by the processing circuitry wherein the fourth communication network device is operative to:
receive sense data from a sensing device; and
send the sense data and a monitoring location of the sensing device to the DSF NE.

36. The monitoring system of claim 35, wherein the ESF comprises an electronic nose function (ENF) operative to receive smell data from an electronic nose, an electronic tongue function (ETF) operative to receive taste data from an electronic tongue, and/or an electronic eye function (EEF) operative to receive visual data from an electronic eye.
